(19) United States
(12) Patent Application Publication
(10) Pub. No.: US 2007/0022149 A1
(43) Pub. Date: Jan. 25, 2007

(54) System and method for concurrent garbage collection

(75) Inventors: David F. Bacon, Sleepy Hollow, NY (US); Perry Cheng, New City, NY (US); David P. Grove, Ridgefield, CT (US); Martin T. Vechev, Port Moody (CA)

Correspondence Address: FLEIT, KAIN, GIBBONS, GUTMAN, BONGINI & BIANCO PL, 551 NW 77TH STREET,, SUITE 111, BOCA RATON, FL, 33487, US

(73) Assignee: INTERNATIONAL BUSINESS MACHINES CORPORATION, ARMONK, NY (US)

(21) Appl. No.: 11/188,024

(22) Filed: Jul. 22, 2005

(51) Int. Cl. G06F 17/30

(52) U.S. Cl. 707/206

(57) ABSTRACT

A method is provided for garbage collection in a computer system that executes at least one mutator. The collector scans objects stored in a memory of the computer system so as to create a wavefront behind which are the objects that have already been scanned. The collector records progress information that indicates the collector's progress in scanning the fields of at least one of the objects, and the behavior of the mutator is changed when mutating the one object based on the progress information that is currently recorded. In another method, the collector scans objects stored in a memory of the computer system so as to create a wavefront behind which are the objects that have already been scanned, and reference counts are maintained behind the wavefront such that each of the reference counts indicates the number of pointers from already scanned fields of objects to unscanned objects.

### FIELD OF THE INVENTION

The present invention relates to computer systems, and more specifically to systems and methods for concurrent garbage collection in a computer system.

### BACKGROUND OF THE INVENTION

In a computer system, “garbage collection” refers to a process of identifying unused areas of memory. In an object oriented computing language, the computer system executing the program allocates memory for each of the objects. Memory is allocated from and freed to the heap in blocks of one of a number of sizes. Eventually there are some objects that are no longer being referenced by the program, and a garbage collection process reclaims the memory allocated for such objects to make this memory again available for use. One type of garbage collection process automatically determines which blocks of memory are in use by marking objects, and collects all of the unmarked blocks of memory and returns them to the heap. Such a garbage collection process is known as “mark-and-sweep collector” because unused portions of memory are marked as garbage during a mark phase and then removed from allocated memory in a sweep phase. Although the process of garbage collection frees memory, its use of system resources such as processor time can affect the running of the application program, which is known as the “mutator”. More information on conventional garbage collection algorithms can be found in “Garbage Collection” by Richard Jones and Rafael Lins (John Wiley & Sons, 1996), which is herein incorporated by reference in its entirety.

The wide acceptance of the Java programming language has brought garbage-collected languages into the mainstream. However, the use of traditional synchronous (or “stop-the-world”) garbage collection is limiting the domains into which Java and similar languages can expand. A synchronous collector pauses the execution of the application program (i.e., the mutator) while an entire mark-and-sweep collection is performed. This can interrupt the application program for a relatively long time so as to create unacceptable delays. On the other hand, a “concurrent” collector performs its operations while the application program continues to run. This reduces pauses, but introduces complexities into the garbage collection process because the running application program can alter the data structure during the garbage collection process.

The need for concurrent garbage collection is primarily being driven by two trends: increased heap sizes, which make the pauses longer and less tolerable; and an increase in the use and complexity of real-time systems, for which even short pauses are often unacceptable.

Unfortunately, concurrent garbage collectors are one of the more difficult concurrent programs to construct correctly. For example, many times a bug in a concurrent garbage collector manifests itself only in the field because concurrent bugs generally have a non-deterministic effect on the system and are non-repeatable, so that connecting the cause of the error to the observed effect is particularly difficult. Concurrent collectors are complex to describe, verify, and implement.

There are many conventional incremental and concurrent garbage collection processes, but there has been little comparative evaluation of the properties of the different algorithms due to the complexity of implementing even one algorithm correctly. Because of these constraints, conventional concurrent systems are generally not quantitatively compared against each other and there is a poor understanding of the relationships among the different concurrent schemes. This has precluded systematic study and comparative evaluation.

For example, early concurrent collectors were all “incremental update” collectors that rescan the object graph to chase down modifications to the object graph that are made by the program during the collection process. The costs and benefits of the different incremental update techniques have not been systematically studied. Further, later developed “snapshot” collectors do not require any rescanning of the object graph, but also do not attempt to collect any garbage allocated after the collection process has begun. Thus, a snapshot collector trades off a potential increase in floating garbage for reliable termination. However, the costs and benefits of snapshot collection as compared to incremental update collection have not been systematically studied.

### SUMMARY OF THE INVENTION

One embodiment of the present invention provides a method for garbage collection in a computer system that executes at least one mutator. According to the method, the collector scans objects stored in a memory of the computer system so as to create a wavefront behind which are the objects that have already been scanned, with at least some of the objects having multiple fields. The collector records progress information that indicates the collector's progress in scanning the fields of at least one of the objects, and the behavior of the mutator is changed when mutating the one object based on the progress information that is currently recorded.

Another embodiment of the present invention provides a method for garbage collection in a computer system that executes at least one mutator. According to the method, the collector scans objects stored in a memory of the computer system so as to create a wavefront behind which are the objects that have already been scanned, with at least some of the objects having multiple fields. Reference counts are maintained behind the wavefront such that each of the reference counts indicates the number of pointers from already scanned fields of objects to unscanned objects.

A further embodiment of the present invention provides a method for garbage collection in a computer system that executes at least one mutator. According to the method, the collector scans objects stored in a memory of the computer system so as to create a wavefront behind which are the objects that have already been scanned by the collector, with at least some of the objects having multiple fields. After the scanning step, the collector sweeps the memory to reclaim all of the objects that were determined to be unreachable in the scanning step. The collector maintains progress information indicating the collector's progress in sweeping the memory, and the mutator uses the progress information to maintain a state of at least one of the objects.

Yet another embodiment of the present invention provides a computer-readable medium encoded with a program for such a garbage collection method by a collector.

Still another embodiment of the present invention provides a garbage collection system for a computer system that performs such a garbage collection method.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIGS. 1A and 1B show pseudo-code for an exemplary implementation of the abstract collector algorithm;

FIG. 1C shows shared variables used in the abstract collector of FIGS. 1A and 1B;

FIG. 2 shows pseudo-code for an exemplary mutator that interacts with the abstract collector of FIGS. 1A and 1B;

FIG. 3 shows pseudo-code for a Hybrid collector according to one embodiment of the present invention;

FIG. 4 shows the maximum heap size for an exemplary implementation of the Hybrid collector of FIG. 3 versus the maximum heap size for other collectors;

FIG. 5 shows the total execution time for an exemplary implementation of the Hybrid collector of FIG. 3 versus the total execution time for other collectors;

FIGS. 6A and 6B are more detailed graphs showing the behavior of the Hybrid collector of FIG. 3 and the other collectors for one benchmark; and

FIG. 7 is a block diagram of an exemplary computer system useful for implementing the present invention.

### DETAILED DESCRIPTION OF PREFERRED EMBODIMENTS

Preferred embodiments of the present invention will be described in detail hereinbelow with reference to the attached drawings.

One embodiment of the present invention provides a Hybrid collector that reduces floating garbage while terminating quickly. The Hybrid collector can be viewed as a new snapshot algorithm that allocates objects unmarked (“white”) and reduces floating garbage without the rescanning of the heap that is required by incremental update algorithms.

An exemplary concurrent collector using the Hybrid process has been implemented. The performance of the exemplary concurrent collector has been compared (in terms of space, time, and incrementality) against implementations of a number of conventional collectors in a production quality runtime system. This comparison showed that the conventional incremental update processes sometimes reduce memory requirements, but they also sometimes take longer due to recomputation in the termination phase. The exemplary Hybrid collector was shown to have memory requirements similar to incremental update collectors, while generally being faster due to avoidance of recomputation in the termination phase.

Additionally, there is presented a single high-level abstract algorithm for concurrent collection that subsumes and generalizes several previous concurrent collector techniques. This algorithm is significantly more precise than previous algorithms (at the expense of constant-factor increases in both time and space), and more importantly yields a number of insights into the operation of concurrent collection. For example, the operation of concurrent write barriers can be viewed as a form of degenerate reference counting. The abstract algorithm does true reference counting and is thus able to find live data more precisely. Existing snapshot and incremental update collectors can be derived from the abstract algorithm by reducing precision. In other words, existing algorithms can be viewed as instantiations of the abstract algorithm that sacrifice precision for compactness of object representation and speed of the collector operations (especially the write barriers).

It has been shown that for synchronous (“stop-the-world”) garbage collection, tracing and reference counting can be considered as dual approaches to computing the reference count of an object. Tracing computes a least fixpoint, and reference counting computes a greatest fixpoint. The difference between the greatest and least fixpoints is the cyclic garbage. Furthermore, all collectors could be considered as a combination of tracing and reference counting, and any incrementality is due to the use of a reference counting approach with its write barriers.

The abstract concurrent collection algorithm makes use of this framework and extends it to concurrent tracing collectors. It is shown that concurrent tracing collectors are also a tracing/reference counting Hybrid. The collector traces the original object graph as it existed at the time when collection started, but does reference counting for pointers to live objects that could be lost due to concurrent mutation.

The abstract concurrent collection algorithm is designed for maximum precision and flexibility, and keeps much more information per object than is desirable in most practical implementations. However, the space overhead is only a constant factor, and thus does not affect the asymptotic complexity of the algorithm, while the additional information allows a potential reduction in complexity. Similarly, a number of operations employed by the abstract algorithm also have constant time overheads that are undesirable in most practical collectors. In particular, there is no special treatment of stack variables. Stack variables are assumed to be part of the heap and therefore every stack operation may incur a constant-time overhead for the collector to execute an associated barrier operation. However, there are a number of collectors for functional languages that treat the stack in exactly this way.

Further, the abstract algorithm is non-moving and concurrent, but not parallel. That is, the collector is single-threaded. The concepts, however, are easily extendable to algorithms using multiple spaces, such as generational ones. Furthermore, the algorithm performs synchronization with atomic sections rather than isolated atomic (compare-and-swap) operations. Atomic sections are relatively expensive on a multiprocessor, so although the algorithm can be executed on a multiprocessor it is better suited to a uniprocessor system based on safe points, in which low-level atomicity is a by-product of the implementation style of the run-time system.

In the abstract algorithm, the concurrency between the mutators and the collector is bounded by a single cycle. This is a common underlying assumption in most practical algorithms. Essentially, this means that all mutator operations started in collector cycle N finish in that cycle, and do not carry over to cycle N+1. No pipelining between the collector phases is assumed: sweeping is followed by marking.

Because no information flows from one collector cycle to the next, different concurrent algorithms can be utilized for every collector cycle. That is, it is possible to dynamically switch between the algorithms since no information flows from one cycle to the next.

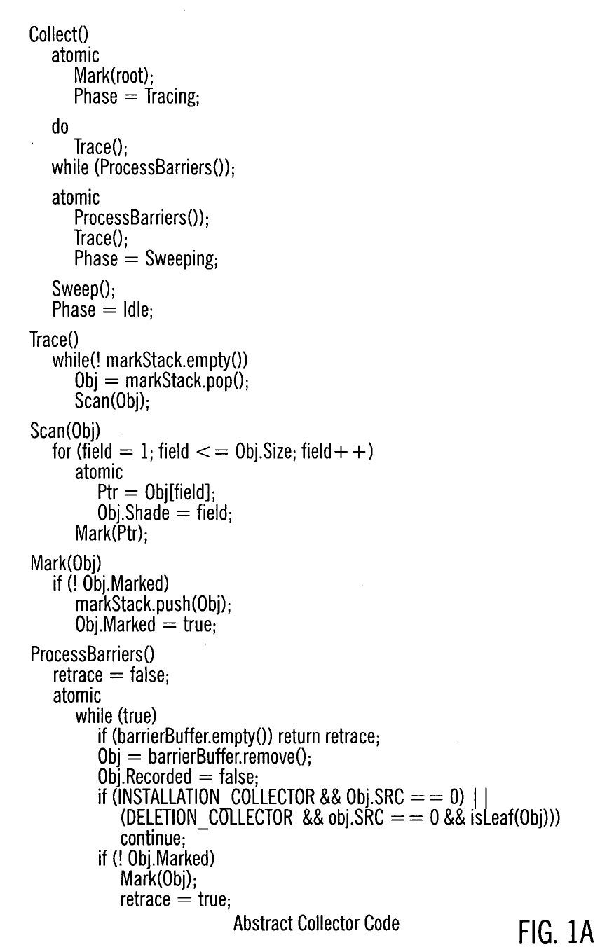

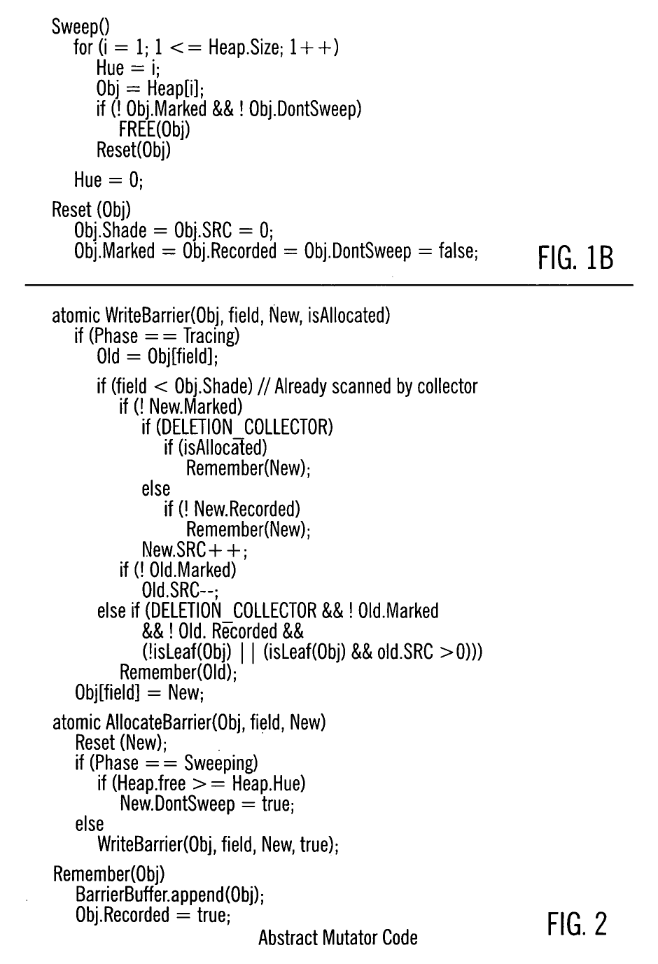

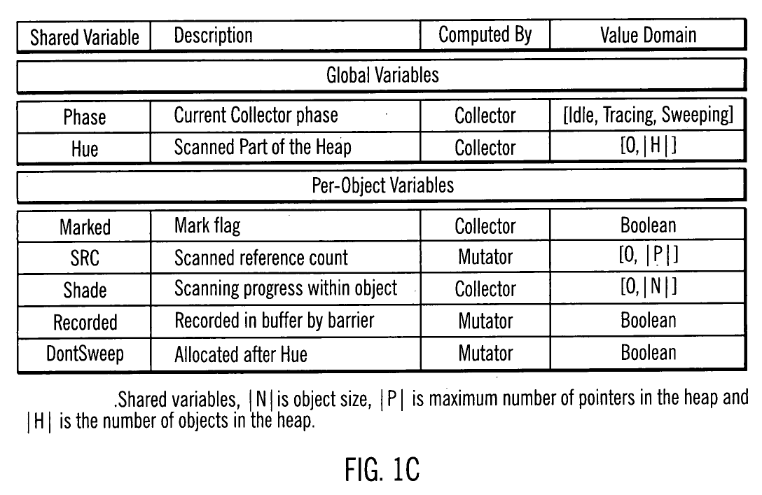

FIGS. 1A, 1B and 2 show an exemplary implementation of the abstract algorithm that uses the variables shown in FIG. 1C. For the sake of simplicity, this implementation makes a number of assumptions about the heap. It is assumed that all heap objects are the same size S and consist only of collector meta-data and object data fields which are all pointers. The fields of an object X are denoted X[1] through X[S].

There will first be described the outer collection loop and the tracing phase of the collection cycle. The Collect( ) procedure is invoked to perform a (concurrent) garbage collection. When it starts, the Phase of the collector is Idle. The procedure first atomically marks the root object and sets the collector phase to Tracing. Atomicity is required because mutators can perform operations that are dependent on the collection phase. (Because all variables live in the heap, there is only a single root that must be marked atomically. In a practical collector that avoided write barriers on stack writes, this single operation would be replaced by atomic marking of all of the roots, which could be on stacks or on global variables.)

The core of the algorithm is the invocation of Trace( ), which is performed repeatedly until the concurrently executing mutators have not modified the object graph in a way that could result in unmarked live objects. Tracing in this abstract algorithm is very similar to the tracing in a synchronous collector: objects are repeatedly retrieved from the mark stack and scanned.

Like a standard tracing collector, the Scan( ) procedure iterates over the fields of the object and marks them. However, as each field is read the “Shade” of the object is incremented. This use of “shades of gray” is one of the generalizations of the abstract algorithm. The color of an object represents the progress of the tracing wavefront as it sweeps over the graph. Many concurrent collectors use the well-known tri-color abstraction in which an object is “white” if it has not been seen by the collector, “gray” if it has been seen but all of its fields have not been seen, and “black” if both it and all of its fields have been seen. However, the tri-color abstraction loses information because it does not track the progress of sweeping within the object. Fundamentally, the synchronization between the collector and the mutator depends on whether or not an object being mutated has been examined by the collector. Therefore, by losing information about the marking progress, the precision of the algorithm is compromised.

The “Shade” of an object is a more detailed coloring in which objects are still white, gray, or black, but there are multiple shades of gray. The “Shade” of an object is the number of fields of the object that have been seen, and thus represents the exact progress of marking within the object. When Shade is “0” then the object is white, when Shade is the same as the number of fields in the object then the object is black, and when Shade is between these two values then it is a shade of gray. The use of the shade information is described below.

Once the Scan( ) procedure has updated the shade, it marks the target object. The Mark( ) procedure pushes the object onto the mark stack if it was not already marked.

The mutator interacts with the collector in the WriteBarrier( ) procedure, in which the mutator acts to modify the object graph. The connectivity graph can be modified by both pointer modification and object allocation. While in this implementation of the algorithm the entire write barrier is atomic, finer-grained concurrency is provided in further implementations.

The write barrier procedure receives a pointer to the object being modified, the field in the object that is being modified, the new pointer that is being stored into the object, and a flag indicating whether the new pointer refers to an object that was just allocated.

If the collector is not in its tracing phase, the write barrier procedure simply performs the write because only the tracing phase determines the reachability of objects. In other words, only object graph mutations during tracing can affect reachability (object graph additions via allocation require some additional synchronization that is described below).

In a concurrent interleaving between the mutator and the collector, the mutator may accidentally hide pointers during collector heap marking. This can result in the concurrent collector erroneously collecting live objects if the collector does not find the hidden pointers during the tracing phase. A live object can be lost if and only if:

(1) it is stored into a location in the heap that has already been scanned by the collector, and

(2) all paths to that object starting from an object the collector will see in this cycle are destroyed.

If a pointer to an unmarked object X is stored into a scanned portion of the heap, yet the object can be reached transitively through an unscanned part of the heap which the collector is going to examine, then the collector will reach object X. Alternatively, if a pointer from an unscanned portion of the heap is destroyed and unmarked object X is not pointed to from a scanned portion of the heap, then either the collector will reach X through another path or the object will become garbage. Therefore, both conditions must hold for a live object to escape from the collector. Another formulation of this is that an object may be lost if and only if it is stored behind the tracing wavefront and then deleted in front of that wavefront.

Since the two events that correspond to the two conditions are separated in time, an object can be protected at either of these two points in time: (1) when a pointer is stored into a scanned portion of the heap, or (2) when a pointer in an unscanned portion of the heap is overwritten. Saving the pointer based on condition (1) is an “installation barrier” (or snapshot write barrier), and saving the pointer based on condition (2) is a “deletion barrier” (or incremental update write barrier). In other words, the installation barrier protects the object when a pointer to it is installed, while the deletion barrier protects the object when a pointer to it is destroyed. The Dijkstra algorithm described in R. Jones et al., “Garbage Collection” (John Wiley & Sons, 1996) on pages 191-193 is an instance of an installation barrier, while the Yuasa algorithm described on pages 189-191 is an instance of a deletion barrier.

This abstract collector is a combination of tracing and reference counting in which the reference counting is done in the write barrier. In particular, a count is maintained of the number of references to an unmarked object from scanned portions of the heap. This count is called the “Scanned Reference Count” (SRC) and allows more precise use of information for condition (1). In particular, the SRC allows reachability decisions to be deferred from the time of the write barrier to the time when collector tracing is finished. For example, if a pointer to an object is installed into the scanned portion of the heap, and subsequently removed from the scanned portion of the heap, then it cannot possibly affect the liveness of the object. More generally, the two conditions listed above can be refined to the following. A live object can act as a root of lost objects if and only if:

(1) its scanned reference count is non-zero, and

(2) it is not marked by the time tracing finishes.

Besides pointer assignments, the mutator can also add objects to the connectivity graph through the AllocateBarrier( ) procedure. Similarly to pointer assignments, in such an allocation the mutator interacts with the tracing phase of the collector. In addition, allocation also interacts with the sweeping phase of the collector.

In terms of reachability, if the collector is in its tracing phase, object allocation can be seen as just another pointer modification event. The main difference between allocation and pointer writes is that upon allocation it is known that the new pointer is unique and that the new object does not contain any outgoing pointers.

During the sweeping phase, the collector iterates over the heap, reclaims all unreachable objects, and resets the state of the live objects. The “Hue” of the heap indicates which parts of the heap that the collector has passed. This variable is similar to Shade, except Shade is applied per object while Hue is applied per heap. That is, there is only one Hue variable. Similarly to Shade, the Hue variable is monotonic within the same collector cycle.

If the mutator allocates during the collector's sweeping phase, a mechanism is required to protect the object from being collected erroneously. The field “DontSweep” indicates if the object has been allocated in a part of the heap that the collector has yet to reach in its sweeping action.

The abstract algorithm maintains rich object-level and heap-level information. The SRC information can be used for safety purposes. The safety condition is violated if by the end of the tracing phase the object is not marked, yet it is still reachable. That is, the SRC is the scanned reference count of an object, and the source of a safety violation is unmarked objects whose SRC(X)>0. There are two points in the collector algorithm where SRC plays an important role. The first point is during the tracing phase at a write barrier point. The second point is after the tracing phase has completed. At the first point, the mutators have to make a reachability decision, while at the second point it is the collector that is making the reachability decision.

In particular, in the write barrier the mutator detects a potential problem and nominates a candidate pointer for the collector. Subsequently, before the termination of its tracing phase, the collector examines the nominated pointers and optionally discards unnecessary candidates.

When the mutator hits the write barrier, it can protect an object using either the installation choice or the deletion choice. Intuitively, to protect an object, the mutator speculates about reachability, since it has no knowledge of how the graph changes before the collector has finished tracing. In the abstract algorithm, the mutator detects a potential problem, but does not make explicit decisions whether the object is reachable at the end of tracing.

The mutator can use the shade of the object to determine what actions, if any, need to be taken to protect objects. For example, if the field being written has not yet been scanned (field>=Obj.Shade), then no action is needed for the installation choice. If the field has been scanned (field<Obj.Shade) or the deletion choice is being used, then additional checks are performed as described below.

For the deletion choice, if the object's SRC is >0 and a pointer to object X is overwritten, the mutator speculates that this could be the last pointer from an unscanned portion of the heap which the collector is about to visit. Since a pointer has already been stored into a scanned portion of the heap, this object represents a potential root for objects reachable solely from X. In this case, the mutator protects object X directly.

If a pointer to an object Y is overwritten and SRC(Y) is 0, then object Y does not need to be protected because no pointer to it from a scanned portion of the heap exists. However, objects transitively reachable from Y may need to be protected. The specific situation is when there exists an object X which is only reachable through a path starting at Y. When the unscanned pointer to Y is destroyed, the mutator speculates that it is destroying the only path to object X. If SRC(X) is >0, then the object will be lost. Therefore, object X needs to be protected transitively.

Although in the deletion choice the mutator always records the overwritten target, it does so with two entirely different purposes. In one case it protects an object directly and in another case it protects an object transitively. Using the insertion choice, the object is remembered as soon as the SRC becomes >0. Essentially, this choice protects objects directly rather than transitively. The insertion choice speculates that right after the SRC becomes >0, an unscanned pointer will be destroyed.

Note that the deletion choice potentially reasons about something which has already occurred, that is, the SRC of an object has become >0. The installation choice speculates about the future, that is, guesses that eventually an unscanned pointer will be destroyed. Although the deletion choice reasons about the past and therefore should have more information, it has no practical way of finding out those transitive objects where SRC>0. To do so would require tracing through such object and remembering all reachable objects where SRC>0. Because it cannot reason about those transitive objects, it must remember every overwritten value. In contrast, the insertion has an immediate access to the critical object. Note that, if the deletion choice had perfect information about the transitive objects whose SRC is >0, then it would always remember fewer pointers than the installation choice.

Besides pointer events, allocation can also modify the object graph. As mentioned above, allocation can be seen as an instance of a write barrier. In allocation, the object is protected directly rather than transitively. With the installation choice, allocation is handled in exactly the same way as a normal pointer store. When using the deletion choice, if the resulting pointer from an allocation request is stored into a scanned portion of the heap, then it is possible that the object will be lost. In this case, allocation can be thought of as a normal pointer store, except that immediately after the pointer store into a scanned region of the heap, an unscanned virtual pointer to the object is overwritten. Since the virtual event cannot be captured by the barrier, we simulate it in the barrier. The flag isAllocated is passed for this reason from the AllocateBarrier( ) to the WriteBarrier( ) procedure. Thus, a deletion write barrier is essentially forced to remember the pointer.

Once the collector has finished the initial tracing of the heap, there might be a number of unmarked but reachable objects. These are the unmarked candidates nominated by the mutator. However, it is possible that in between the time when the mutator nominated a candidate and the time when the collector saw it, the candidate became no longer necessary.

Similarly to the mutator's pointer selection mechanism, the collector also uses a mechanism to filter out unnecessary candidates. This selection mechanism for the collector is the same as that for the mutator, as shown in the write barrier processing phase by the procedure ProcessBarriers( ). Although the same mechanism is used, it is possible that candidates nominated by the mutator are ignored by the collector.

In particular, the collector examines all unmarked objects nominated by the mutator. The SRC field of such objects implies different reachability semantics. The two categories of objects are: (1) SRC>0, or (2) SRC=0 (SRC<0 is an impossible case).

If the installation choice is used and if the object's SRC is >0, when the collector sees such a pointer, the corresponding object must be retraced. If the object's SRC is 0, then the object was recorded by the mutator, but before tracing finished its SRC dropped to 0. Such objects are skipped by the collector in this phase. They have either become garbage or are live but hidden. In the latter case, the object is reachable transitively from a chain of reachable objects starting at an object whose SRC is >0. Therefore, only objects whose SRC is >0 need to be retraced.

In contrast, with the deletion choice, the collector has to mark all remembered objects, regardless of whether the SRC is >0 or not.

Regardless of the write barrier choice, objects whose SRC>0 act as a root of a data structure which could potentially contain other reachable objects whose SRC=0. More formally, if after tracing has completed an object X′ is unmarked and its SRC(X′)=0 and the object is reachable, then there exists another reachable unmarked object X where SRC(X)>0.

Note that maintaining an accurate SRC has several advantages for the installation type collector. First, it prevents mutator-induced floating garbage. That is because at the time a pointer store occurs, the mutator suggests objects which could be potentially hidden from the collector. It does not make an explicit decision whether they will actually be reachable once the tracing is complete. The reachability is left up to the collector when the barrier tracing phase occurs. Because of the SRC the mutator does not need to make an explicit decision about reachability. Second, the collector must start rescanning only from specific objects, that is, objects where SRC>0. It does not need to consider objects where SRC is 0. The SRC also benefits the deletion collector in being able to differentiate between transitively protected and directly protected objects.

The abstract algorithm provides a much higher degree of precision than previously published and implemented algorithms. Practical concurrent collector algorithms that trade precision for efficiency will now be derived via orthogonal transformations of the abstract collector. Because the transformations are orthogonal and because the reduction in precision can be modulated, this framework allows the derivation of a much broader set of algorithms than have previously been described.

The possible transformations include: (1) a reduction in write barrier overhead by treating multiple pointers as roots; (2) a reduction in root processing by eliminating re-scanning of the root set; (3) a reduction in object space overhead and barrier time overhead by reducing the size of the scanned reference count (SRC); (4) a reduction in object space overhead by reducing the precision of the per-object shade; and (5) a reduction in object space overhead and increase in the speed of the write barrier by conflation of shade and SRC. While these transformations change the set of collected objects, they are invariant-preserving in that live data is never collected (the collector safety property).

First, there is considered a root set transformation. In the abstract algorithm, all memory is reached from a single root. Thus, stacks and global variables are treated as objects like any other. However, the cost of such an approach is generally prohibitive because the mutation rate of the stack is extremely high and every stack mutation must include a write barrier. Therefore, the abstract algorithm is transformed into an algorithm that partitions memory into two regions: the roots and the heap. The roots generally include the stack and may also contain the static variables and other distinguished pointer data. Although a two-level splitting is considered in these examples, other partitioning is possible.

The main reason for splitting the heap into two distinct memory spaces is that regions such as thread stacks exhibit a very high mutation rate. Utilizing a write barrier on such spaces can lead to severe performance degradation. Thus, there is provided a non-barriered storage space known as the “roots storage”, and a barriered storage space known as the “heap storage”.

The treatment of the roots storage is as follows. First, in the beginning of every collector cycle, the mutators are stopped and all heap objects directly reachable from roots are marked, placing them on the work queue (i.e., the mark stack). This is similar to the one space collector, except that here more than one root must be marked. Second, it is assumed that the heap does not contain pointers to the roots storage. That is, there are only pointers from roots to the heap, but not from the heap to the roots. Third, it is assumed that the roots storage does not contain objects, but only outgoing pointers to the heap. With this treatment, the roots storage is very similar to mutator stacks.

Despite adding an additional memory partition, the SRC field is used similarly to the single space collector. The key is to recognize that the roots storage acts as a scanned object. That is, during heap tracing, any pointer modification in the roots affects the SRC field. The fundamental difference is that a write barrier is not used on the roots. Because of this, an accurate SRC can no longer be maintained.

Therefore, the introduction of the additional roots space creates three uncertainties. First, if an installation choice is used, an existing object on the heap could escape into the roots during tracing. That is, before the collector has reached the object, the mutator could copy all of its heap pointers into the roots and subsequently could destroy these heap pointers. Second, if the deletion choice is used, an object allocated in this cycle could escape into the heap. This occurs when the object is just allocated and placed on the root. The mutator then moves that unique pointer into a scanned portion of the heap so as to hide the object from the collector. This condition occurs because there is no tracking of when pointers in the roots are destroyed. Third, the case in which newly allocated objects are reachable from the roots only needs to be detected. This case can occur when an object is allocated, yet, it never escapes into the heap. Note that this case is similar to the first uncertainty, if allocation always produces a unique pointer.

These three uncertainties arise because accurate SRC information cannot be maintained. In the space-time plane, maintaining an accurate SRC leads to reduced floating garbage (space), but increases the mutator work (time). The different algorithmic choices explored below are essentially points in the space-time plane. Some perform more mutator work (increase in time) in order to reconstruct the SRC more accurately and hence reduce the floating garbage (decrease in space) while others increase the space factor in favor of faster termination.

Next, there is considered root re-scan elimination. The special treatment of roots does not affect the precision of the collector if root re-scanning is used to correct the SRC. However, re-scanning is undesirable because it increases the running time. If root re-scanning is eliminated, then the SRC values may be under-approximations (because the increment of the final pointer stored in a root will have been missed). Since increments may keep objects live that would otherwise have been collected, this means that any reclamation of an object based on its SRC being 0 is unsafe. Therefore, the algorithm must be conservative in such cases and precision will be sacrificed.

Furthermore, when an installation barrier is used the installation of pointers into the scanned portion of the heap is what causes them to be remembered in the barrier buffer for further tracing during barrier processing. Thus, regardless of the imprecision of the SRC, objects that would have had a non-zero SRC must be seen during barrier processing. In effect, this means that re-scanning cannot be eliminated if the installation barrier is used.

If the deletion barrier is used, the only pointers to new objects that are remembered in the write barrier are the newly allocated objects. Therefore, as long as those objects are placed in the barrier buffer by the allocator, and the SRC-based computation in the barrier processing is eliminated, then the root re-scanning can be safely eliminated.

Because no collector decisions are based on the value of the SRC, it is redundant and can be eliminated. The result is an algorithm with more floating garbage (in particular, all newly allocated objects are considered live), of which Yuasa's algorithm is an example.

Next there is considered constraints on the space factor (that is, the amount of information kept per object). First, “Shade” can be compressed. The shade of an object represents the progress of the collector as it processes the individual pointers in the object. The precision of the shade can always be safely reduced as long as the processing of the pointers in the object in the write barrier treats the imprecise shade conservatively. In particular, because many objects have a small number of pointers N, it is efficient to treat the shade as a set of three values that represent an object for which collector processing has not yet begun, is in progress, or has been completed. This is the standard tri-color in which the three values are called white, gray, and black, respectively.

When N is small, the chance is low that the mutator will store a pointer into the object currently being processed by the collector, so the reduction in precision is likely to be low. However, with large objects (such as pointer arrays) the reduction in precision can be more noticeable. To compensate, the collector can treat sections of the array independently, in effect mapping equal-sized subsections of the array into different shades.

Additionally, the “Scanned Reference Count” can be compressed. The SRC can range from 0 to the number of pointers in the system. However, the number of references to an object is usually small, and the SRC will be even lower (since it only counts references from the scanned portion of the heap to unmarked objects). Therefore, the SRC can be compressed and the loss of precision is likely to be low.

However, the compression must be conservative to ensure that live objects are not collected. This is accomplished by making the SRC into a “sticky” count. That is, once it reaches its maximum value, it is never decremented. As a result, the SRC is an over approximation, which is always safe because it will only cause additional objects to be treated as live. If the collector uses an installation barrier. a one-bit SRC is also possible. In this case, the SRC becomes equivalent to the Recorded flag, which allows those two fields to be collapsed.

Further, there can be a conflation of the “Shade” and the “Scanned Reference Count”. If the collector uses an installation barrier with a one-bit sticky SRC and tri-color shade, an object with a stuck SRC must be scanned by the collector. Similarly, a gray object must be scanned by the collector. Thus, the meaning of these two states can be collapsed and the gray color can be used to indicate a non-zero (stuck) SRC, which also represents the Recorded flag.

In one embodiment, the value domain is constrained for the SRC and Shade fields. First, the Marked and Shade fields are compressed into a single two-bit field known as “Color”, which can represent four distinct object states. By doing so, the common three-color abstraction is derived: “white” color denotes that the object is unreachable, “gray” color is reachable and partially scanned, and “black” is reachable and fully scanned.

The SRC is also compressed into a one-bit field known as “SB”. Another bit is also necessary to indicate overflow of the SB value. The one-bit SB field enables an accuracy to be maintained of up to a single pointer from the scanned portion of the heap. If an overflow occurs, then the bit can no longer be decremented. Note that for better accuracy more bits can be added to the field. For example, for an accuracy of up to seven pointers, three bits are required. In the special case where no space can be devoted to the SB field, it is assumed that its value is always in an overflowed state.

The net result of the space reduction is that three bits of overhead are maintained per object: two bits for the Color field and one bit for the SB field.

The imprecision introduced by abstracting the specific field values can lead to increased floating garbage from two places. First, with the abstraction of Shade, it can no longer be reasoned with certainty whether there is being manipulated (installation or deletion) a pointer within a scanned part of the heap. The uncertainty is introduced by the gray color which abstracts the progress of the collector through the object. Second, if the SB field overflows, yet the object became unreachable before tracing has completed, the collector will consider the object and everything reachable from it live.

Starting from the abstract collector and using the transformations described above, various practical collector algorithms will now be derived. Each collector is fundamentally a point in the space-time plane. The floating garbage regulates the space factor while the amount of collector and mutator work determines the time factor.

The first derived collector is an installation scheme. With installation collectors, newly allocated objects cannot escape into the heap because the barrier will protect against such cases. It will increment the SRC of a pointer stored into a scanned portion of the heap.

On the other side, existing objects can escape into the roots. This occurs when a heap pointer is copied into the roots and subsequently destroyed. Because root stores are not barriered, it cannot be detected when a pointer has escaped into the roots. Therefore, the algorithm must perform roots rescanning in order to protect existing objects escaping into the roots.

Rescanning can also be used to detect newly allocated objects escaping into the roots. Therefore, no special protection is necessary for newly allocated objects, since they will either be barriered or will be found on roots rescanning. Therefore, such objects can be allocated white. One implication is that this also allows the objects to die during this collector cycle.

The collector still makes use of the SB field. Similarly to the SRC for the abstract collector, the field prevents the mutator from making explicit reachability decisions when the SB oscillates between 0 and 1. If the field overflows or the SB field is eliminated, oscillation is no longer possible and the worst case must always be assumed. That is, when a pointer is installed, the object becomes reachable for this collector cycle. Eliminating the SB field leads to a Dijkstra-like collector. That is, objects are allocated white and on every barrier store, if the pointer is installed into a scanned portion of the heap, the object becomes live for this cycle.

The incremental collector is particularly suited for applications which generate large quantities of floating garbage, both by allocating many short-lived objects and by overwriting last references to existing objects.

There is an implicit benefit on floating garbage from rescanning the roots. The barrier buffer might contain objects whose SB is 0 (that is, objects which were remembered by the barrier, but later their SB dropped to 0). Similarly to the abstract installation collector which ignores objects whose SRC is 0 when performing barrier rescanning, the incremental collector also ignores objects where the SB is 0. This can lead to a reduction in floating garbage.

The deletion choice abstract collector remembers every overwritten pointer. Moreover, during its barrier processing phase, the collector marks as live every remembered pointer. While the abstract algorithm computes the SRC field, it does not make use of it. Nonetheless, the abstract algorithm did provide an insight that this field could be used to differentiate between protecting an object transitively or protecting an object directly. Having compressed the SRC into the SB, that insight can still be used. Granted, in some cases due to imprecision, a transitive object might be considered a direct object if the SB has overflowed.

In the case where the SB field is ignored, similarly to the abstract collector, every remembered object needs to be marked live. This implies that destruction of a path in the heap connectivity graph is not allowed. Therefore, no existing heap objects can escape into the roots or into the heap. On the other hand, unlike installation collectors, it cannot be detected when a newly allocated object escapes into the heap. This case occurs when pointers to such newly allocated objects are stored into a scanned heap object. Subsequently, the mutator destroys the root pointers. Because the roots are not barriered, it cannot be determined when these destructions occur.

One solution is to prevent such cases from occurring by allocating objects with a black color. With this scheme, no existing or newly allocated objects can escape. Clearly, the algorithm will not require root set rescanning since no objects can escape. This approach trades space (floating garbage) for time (faster termination). This collector corresponds to the well-known Yuasa snapshot collector.

Alternatively, if the SB field is utilized, there can be used the insight from the abstract collector which partitions remembered objects into transitive and direct. If SRC(Y) is 0 and a pointer from an unscanned portion of the heap to Y is overwritten, then that overwritten pointer is remembered. By remembering the pointer to Y, it is not trying to protect Y, but to protect an object X whose SRC is >0 transitively.

A hidden assumption in the above statement is that Y contains outgoing pointers which reach such an object X where SRC(X)>0. Clearly, in cases where Y does not have outgoing pointers, remembering Y is not required. More formally, if a pointer from an unscanned portion of the heap to an object Y is destroyed and SRC(Y) is 0, then that pointer does not have to be remembered if Y does not contain outgoing pointers at the time of the write barrier. In other words, if Y is a leaf object and SRC(Y) is 0, then overwritten pointers to Y from unscanned portions of the heap do not need to be remembered.

There could be many approaches to proving that objects cannot be transitively reached where SRC>0 from Y. One solution is to consider a type-based approach. For example, if the type of object Y is an array of scalars, then Y is a leaf and the above observation can be applied.

This collector is referred to as the “semi-snapshot collector”. The algorithm is only possible if an SRC or an SB field is maintained per object. It does require an additional check in the write barrier for whether the object is a leaf.

Another example of leaves is newly allocated objects. Right after allocation, an object does not contain outgoing pointers. The semi-snapshot collector can therefore consider static leaves as well as dynamic leaves. Static leaves are objects which are always leaves throughout the program execution. Examples of such objects are arrays of scalar values and objects which do not contain pointers. Dynamic leaves are objects which could become non-leaf, but are leaves at the time the barrier occurs. A newly allocated object could be a leaf temporarily. Right after the object is allocated, the mutator could store a pointer into the object making it a non-leaf.

Thus, the Dijkstra algorithm is an abstract installation collector that is derived from the abstract collector by applying the following transformations: (1) Root Sets transformation, (2) Shade compression to tri-color, (3) SRC compression to a single sticky bit, and (4) Conflation of Shade and SRC.

A Steele-like collector is similar to a Dijkstra collector except that its transformation covers a wider range of rescanning. The Steele algorithm is not limited to rescanning only the roots, but can also rescan heap partitions. However, the barrier processing phase and the selection criteria are exactly the same as in the Dijkstra collector.

The Yuasa snapshot algorithm is a deletion collector that is derived from the abstract collector by applying the following transformations: (1) Root Sets transformation, (2) Shade compression to tri-color, and (3) Root Rescan Elimination.

The snapshot collector and the incremental collector represent the two extremes in the space-time plane. The incremental collector attempts to minimize the floating garbage but takes longer to terminate. The snapshot collector minimizes time (mutator and collector work) and therefore terminates faster, but is subject to space (floating garbage) variation. In between the incremental and the snapshot collectors, a number of other approaches exist, such as the following Hybrid collector.

The Hybrid collector is an abstract deletion collector that can be derived from the abstract collector by applying the following transformations: (1) Root Sets transformation, (2) Shade compression to tri-color, (3) SRC compression to a single sticky bit, (4) Conflation of Shade and SRC, (5) Root Rescan elimination for existing objects, and (6) Over approximate Shade.

The first two transformation steps are the same as for the Yuasa algorithm. However, in the Hybrid algorithm, the rescanning of roots is utilized only for newly allocated objects. The roots rescan transformation is parameterized to be active only for existing objects. This produces a deletion Yuasa algorithm for the existing heap graph while maintaining a less restricted policy for newly allocated objects, similarly to the Dijkstra collector. By eliminating rescanning for existing objects, the SRC for those objects can be removed. Whenever the collector encounters an existing object during its barrier processing phase, the object is always marked, without applying any selection criteria.

Additionally, to obtain bounded re-tracing of newly allocated objects triggered by roots rescanning, there is an additional transformation so that if a newly allocated pointer is stored into the heap, the object is marked as reachable for this collection cycle. This simply means that if a newly allocated pointer is stored into the heap, the SRC is always increased, ignoring the color of the destination object. This is an over-approximation transformation on the Shade of the destination object. Thus, the collector only needs to trace from existing objects and not from newly allocated objects.

Instead of using problem detection for newly allocated objects as the snapshot algorithm does, the Hybrid collector utilizes an on-demand or a problem prevention technique. In particular, the snapshot collector can allow newly allocated objects to escape into the heap because pointer destruction is not accounted for in the roots. In the Hybrid collector, newly allocated objects are essentially allocated white. If a newly allocated object attempts to escape into the heap, an incremental-like write barrier is used on that object to color it black either during roots rescanning or during a pointer store in the heap. The write barrier essentially performs dynamic escape analysis on newly allocated objects.

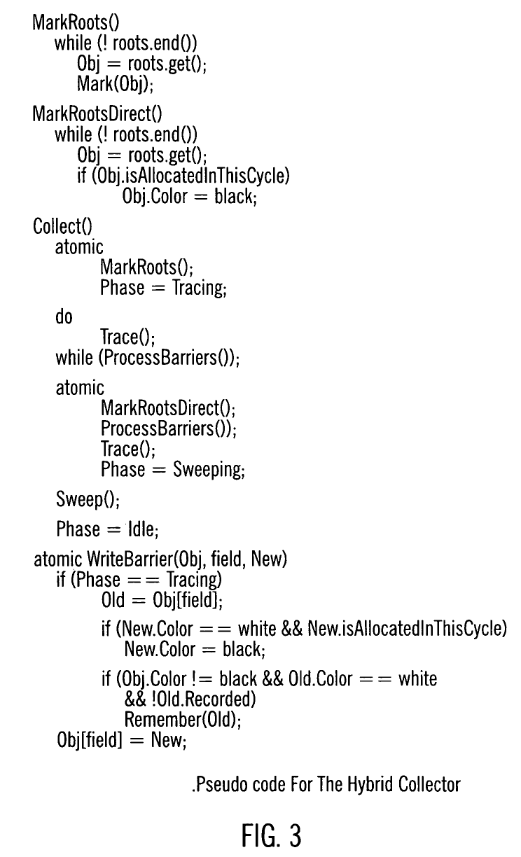

The pseudo-code for a Hybrid collector according to one embodiment of the present invention is shown in FIG. 3. In this embodiment, the MarkRootsDirect procedure performs the one-level deep rescanning procedure for the roots partition while the isAllocatedInThisCycle bit is used to differentiate between newly allocated and existing objects.

The Hybrid collector maintains a separate bit for newly allocated objects and increments the SB field only for those objects. A single-bit SB field could potentially help in eliminating floating garbage. For example, the SB field for many newly allocated objects could oscillate between 0 and 1 and then finally back to 0 before tracing is finished. Alternatively, the SB field can be removed. In that case, whenever an object escapes, the object is colored black. An additional bit “isAllocatedInThisCycle” is introduced to denote whether the object is allocated in this cycle. The bit is set upon object allocation. The option of eliminating the SB field is used in the Hybrid collector of FIG. 3.

One main advantage of the Hybrid collector over an incremental collector is that the Hybrid collector does not need to retrace more than one level deep from the roots. That is, the retracing phase only marks objects directly reachable from the roots. The reason why it is not necessary to rescan through the newly allocated objects which have escaped is two-fold. First, no existing pointers can escape into newly allocated objects (since destruction in the graph is not allowed). Second, no newly allocated objects can escape into other newly allocated objects. This is because as soon as an allocated object is stored into the heap, the write barrier will mark the object.

The Hybrid collector is advantageous for two reasons. First, if the program obeys the generational hypothesis and not many allocated objects escape into the heap, the floating garbage is significantly reduced. Second, the amount of root rescanning work is bounded. In certain domains, such as real-time collectors, bounding space and mutator utilization usage is of primary importance. The Hybrid collector is particularly suited for hard real-time applications in which it is desirable to achieve a bound on the roots rescanning work while reducing the floating garbage.

An exemplary concurrent collector framework in IBM's J9 virtual machine has been implemented as a second generation Metronome real-time collector. This exemplary collector supports both standard work-based collection (for every a units of allocation the collector performs ka units of collection work), as well as time-based collection (the collector runs for c out of q time units).

Only work-based collection is considered below because its use is more common in more widely used soft real-time systems, and it is likely to provide a better basis for comparison with other work. Isolated experiments have shown that the trends reported below for work-based collection generally hold for time-based collection as well.

The exemplary collector is implemented in a J2ME-based system that places a premium on space in the virtual machine, so the microJIT is used rather than the much more resource-intensive optimizing compiler. The microJIT is a high quality, single pass compiler that produces code roughly a factor of two slower than the optimizing JIT. This exemplary system runs on Linux/x86, Windows/x86, and Linux/ARM. The measurements presented below were performed on a Windows/x86 machine with a 3 GHz Pentium 4 CPU and 500 MB of RAM. The measurements presented all use a collector to mutator work ratio of 1.5. That is, for every 6K allocated by the mutator, the collector processes 9K. Collection is triggered when heap usage reaches 10 MB. The SPECjvm98 benchmarks, which exhibit a fairly wide range of allocation behavior (with the exception of compress, which performs very little allocation) have been measured.

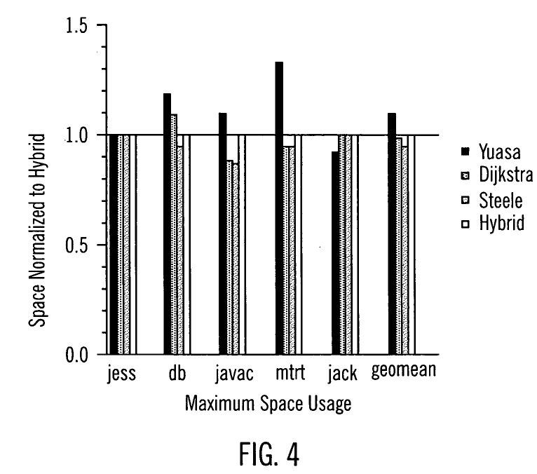

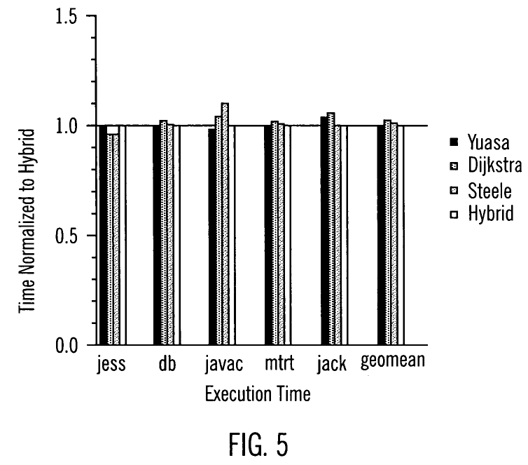

FIGS. 4 and 5 summarize the performance of the four collector algorithms by showing the maximum heap size and total execution time, respectively. Both graphs are normalized to the Hybrid algorithm, and shorter bars represent better performance (less heap usage or shorter execution times). A geometric mean is also shown.

As expected, the incremental update collectors (Dijkstra and Steele) often require less memory than the snapshot collector (Yuasa). This is because the incremental update collectors allocate white (unmarked) and only consider live those objects which are added to the graph. However, there is no appreciable difference on two of the five benchmarks (jess and jack), which confirms that the space savings from incremental update collectors are quite program-dependent.

The use of Steele's write barrier instead of Dijkstra's theoretically produces less floating garbage at the expense of more rescanning, since it marks the source rather than the target object of a pointer update. This means that if there are multiple updates to the same object, only the most recently installed pointer will be rescanned.

However, the Steele barrier only leads to significant improvement in one of the benchmarks (db). This is because db spends much of its time performing sort operations that permute the pointers in an array, and each update triggers a write barrier. With a Steele barrier, the array is tagged for rescanning. But with a Dijkstra barrier, each object pointed to by the array is tagged for rescanning. As a result, there is a great deal more floating garbage because the contents of the array are being changed over time.

The Hybrid collector, a snapshot collector that allocates white (unmarked), significantly reduces the space overhead of snapshot collection. The space overhead over the best collector is at worst 13% (for javac), which is quite reasonable.

While the incremental update collectors are generally assumed to have an advantage in space, their potential time cost is not well understood. Incremental update collectors may have to repeatedly rescan portions of the heap that changed during tracing. Termination could be difficult if the heap is being mutated very quickly.

The measurements show that incremental update collectors do indeed suffer time penalties for their tighter space bounds. The Dijkstra barrier causes significant slowdown in db, javac, mtrt, and jack. The Steele barrier is less prone to slowdown (only suffering on javac) but it does suffer the worst slowdown (about 12%). These measurements are total application run-time, so the slow-down of the collector is very large (representing about a factor of two slowdown in collection time).

Once again, the Hybrid collector performs very well. It usually takes a time that is very close to the fastest algorithm. Thus, the Hybrid collector appears to be a very good compromise between snapshot and incremental update collectors.

Because it only rescans the stack, it suffers no reduction in incrementality from a standard Yuasa-style collector, which must already scan the stack atomically. Its advantage over a standard snapshot collector is that it significantly reduces floating garbage by giving newly allocated objects time to die. But because it never rescans the heap, it avoids the termination problems of incremental update collectors and is still suitable for real-time applications.

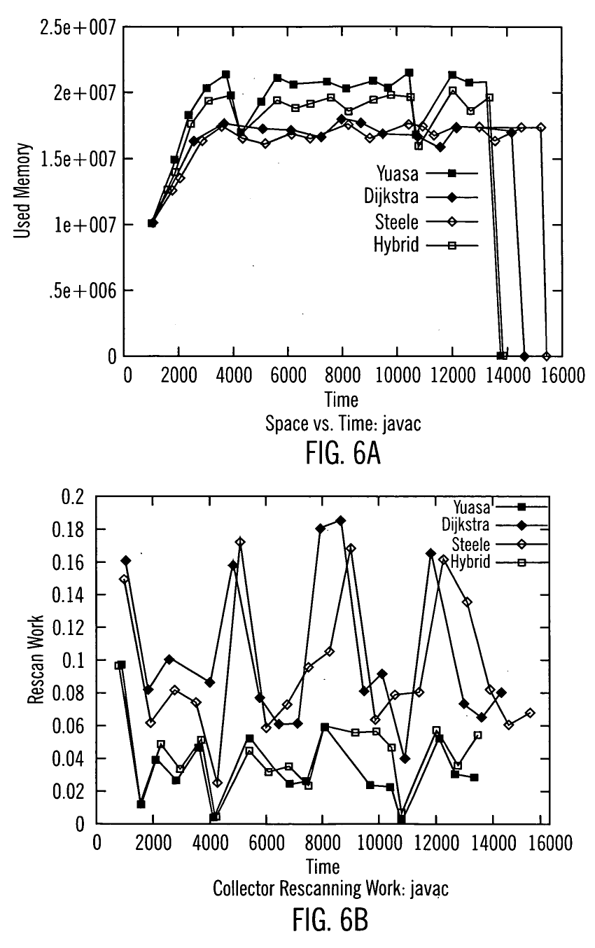

FIGS. 6A and 6B are more detailed graphs showing, for the javac benchmark, the behavior of the four collectors with respect to space utilization and barrier-induced work. Similar detailed graphs were analyzed for the other benchmarks. These graphs demonstrate that the primary reason why the Yuasa and Hybrid algorithms are quicker is that Dijkstra and Steele collectors both scan significantly more data during barrier buffer processing.

FIG. 6A shows space usage over time for the javac benchmark. Each data point represents the amount of data in use when the tracing and barrier processing terminated, but before sweeping. This represents the point of maximum memory use. This graph shows that the Yuasa-style collector consistently uses more memory than the others, but it also terminates the quickest (at termination, memory consumption is 0).

The reason why the Yuasa and Hybrid algorithms are quicker can be seen in FIG. 6B. The Dijkstra and Steele collectors both scan significantly more data during barrier buffer processing. Barrier-induced scanning is still significant even for the pure snapshot (Yuasa) collector because pointers to some objects that are part of the snapshot may have been overwritten and not discovered during marking. However, the total work will be based on the live data in the object graph at the time collection began, whereas in the incremental update algorithms it varies.

The detailed graphs for the other benchmarks clearly showed the rescanning overhead observed above for the db benchmark with Dijkstra's barrier. Rescanning typically causes about 20% of the heap to be revisited, while rescanning for the other three collectors is negligible.

Accordingly, there has been presented an abstract concurrent garbage collection algorithm, and incremental update collectors in the style of Dijkstra and snapshot collectors in the style of Yuasa can be derived from this abstract algorithm by reducing precision through various transformations. Further, insights from this formulation have been used to derive a Hybrid snapshot collector that allocates its objects unmarked, and therefore induces less floating garbage.

The implementation of the collectors in a production virtual machine and a comparison of their time and space requirements have shown that incremental update collectors suffer less floating garbage, while the pure snapshot collector sometimes uses significantly more memory. The Hybrid collector greatly reduces the space cost of snapshot collection. It was also shown that incremental update collectors can significantly slow down garbage collection, leading to noticeable slow-downs in application execution speed. The Hybrid snapshot collector is generally about as fast as the fastest algorithm. For most applications this collector represents a good compromise between time and space efficiency, and has the notable advantage of snapshot collectors in terms of predictable termination.

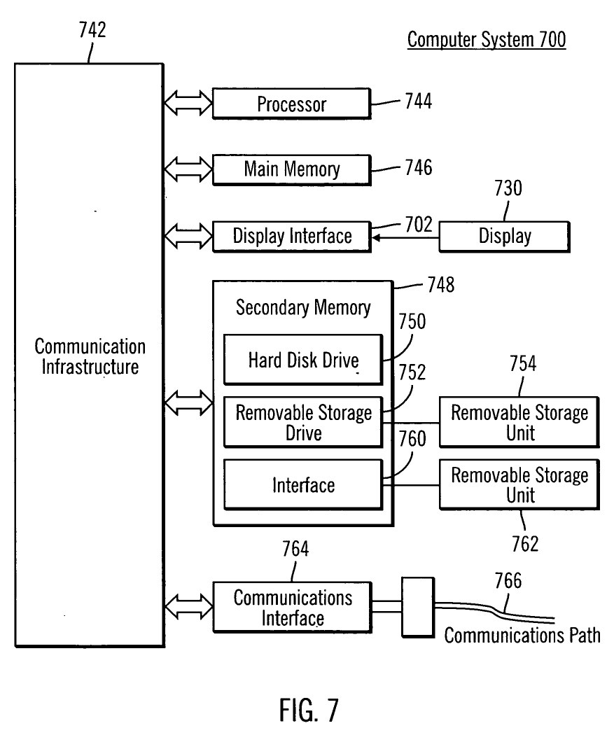

The present invention can be implemented using hardware, software or a combination thereof, and may be implemented in one or more computer systems or other processing systems. An example of such a computer system 700 is shown in FIG. 7. The computer system 700 represents any single or multi-processor computer. In conjunction, single-threaded and multi-threaded applications can be used. Unified or distributed memory systems can be used. Computer system 700, or portions thereof, may be used to implement the present invention. For example, the system 100 of the present invention may comprise software running on a computer system such as computer system 700.

Computer system 700 includes one or more processors, such as processor 744. One or more processors 744 can execute software implementing the processes described above. Each processor 744 is connected to a communication infrastructure 742 (e.g., a communications bus, cross-bar, or network). Various software embodiments are described in terms of this exemplary computer system. In further embodiments, the present invention is implemented using other computer systems and/or computer architectures.

Computer system 700 can include a display interface 702 that forwards graphics, text, and other data from the communication infrastructure 742 (or from a frame buffer) for display on the display unit 730. Computer system 700 also includes a main memory 746, preferably random access memory (RAM), and can also include a secondary memory 748. The secondary memory 748 can include, for example, a hard disk drive 750 and/or a removable storage drive 752 (such as a floppy disk drive, a magnetic tape drive, an optical disk drive, or the like). The removable storage drive 752 reads from and/or writes to a removable storage unit 754 in a conventional manner. Removable storage unit 754 represents a floppy disk, magnetic tape, optical disk, or the like, which is read by and written to by removable storage drive 752. The removable storage unit 754 includes a computer usable storage medium having stored therein computer software and/or data.

In alternative embodiments, secondary memory 748 may include other similar means for allowing computer programs or other instructions to be loaded into computer system 700. Such means can include, for example, a removable storage unit 762 and an interface 760. Examples can include a program cartridge and cartridge interface (such as that found in video game console devices), a removable memory chip (such as an EPROM, or PROM) and associated socket, and other removable storage units 762 and interfaces 760 which allow software and data to be transferred from the removable storage unit 762 to computer system 700.

Computer system 700 can also include a communications interface 764. Communications interface 764 allows software and data to be transferred between computer system 700 and external devices via communications path 766. Examples of communications interface 764 can include a modem, a network interface (such as Ethernet card), a communications port, interfaces described above, etc. Software and data transferred via communications interface 764 are in the form of signals which can be electronic, electromagnetic, optical or other signals capable of being received by communications interface 764, via communications path 766. Note that communications interface 764 provides a means by which computer system 700 can interface to a network such as the Internet.

The term “computer program product” includes a removable storage unit 754, a hard disk installed in hard disk drive 750, or a carrier wave carrying software over a communication path 766 (wireless link or cable) to communication interface 764. A “computer useable medium” can include magnetic media, optical media, semiconductor memory or other recordable media, or media that transmits a carrier wave or other signal. These computer program products are means for providing software to computer system 700.

Computer programs (also called computer control logic) are stored in main memory 746 and/or secondary memory 748. Computer programs can also be received via communications interface 764. Such computer programs, when executed, enable the computer system 700 to perform the features of the present invention as discussed herein. In particular, the computer programs, when executed, enable the processor 744 to perform features of the present invention. Accordingly, such computer programs represent controllers of the computer system 700.

The present invention can be implemented as control logic in software, firmware, hardware or any combination thereof. In an embodiment where the invention is implemented using software, the software may be stored in a computer program product and loaded into computer system 700 using removable storage drive 752, hard disk drive 750, or interface 760. Alternatively, the computer program product may be downloaded to computer system 700 over communications path 766. The control logic (software), when executed by the one or more processors 744, causes the processor(s) 744 to perform functions of the invention as described herein.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for garbage collection by a collector in a computer system that executes at least one mutator, the method comprising the steps of:
scanning by the collector of a plurality of objects stored in a memory of the computer system so as to create a wavefront behind which are the objects that have already been scanned by the collector, at least some of the objects having a plurality of fields;
recording by the collector of progress information that indicates the collector's progress in scanning the fields of at least one of the objects; and
changing the behavior of the mutator when mutating the one object based on the progress information that is currently recorded.

2. The method according to claim 1,
wherein each of the objects stored in the memory has an associated shade value, and
in the recording step, the collector records the progress information for the one object by setting the shade value associated with the one object.

3. The method according to claim 2, wherein in the recording step, the collector increments the shade value associated with the one object each time another of the fields of the one object is scanned.

4. The method according to claim 1, wherein the progress information indicates the exact number of fields of the one object that have been scanned by the collector.

5. The method according to claim 2, further comprising the step of:
maintaining reference counts behind the wavefront such that each of the reference counts indicates the number of pointers from already scanned fields of objects to unscanned objects,
wherein the shade value associated with the object is used to maintain the reference count of the object.

6. The method according to claim 5,
wherein the shade value is compressed into three states, and
the method further comprises the steps of:
allocating an object with its associated shade value set to a state that indicates that no fields of that object have been scanned; and
remembering an over-written pointer if that over-written pointer is from an unscanned object.

7. The method according to claim 6, further comprising the step of setting the shade associated with an object to a state that indicates that all of the fields of the object have been scanned if the object was allocated during the scanning step.

8. The method according to claim 7, further comprising the step of upon termination of the scanning step, performing one-level deep rescanning of the objects that are reachable from a stack and registers.

9. The method according to claim 1, further comprising the step of executing the mutator concurrently with the scanning step.

10. A method for garbage collection by a collector in a computer system that executes at least one mutator, the method comprising the steps of:
scanning by the collector of a plurality of objects stored in a memory of the computer system so as to create a wavefront behind which are the objects that have already been scanned by the collector, at least some of the objects having a plurality of fields; and
maintaining reference counts behind the wavefront such that each of the reference counts indicates the number of pointers from already scanned fields of objects to unscanned objects.

11. The method according to claim 10,
wherein each of the objects stored in the memory has an associated SRC value, and
in the maintaining step, the maintains the reference count for one of the objects by setting the SRC value associated with the one object.

12. The method according to claim 11, wherein the SRC value indicates the exact number of pointers from already scanned fields of objects to unscanned objects.

13. The method according to claim 10, further comprising the step of:
recording by the collector of first progress information that indicates the collector's progress in scanning the fields of at least one of the objects;
changing the behavior of the mutator when mutating the one object based on the first progress information that is currently recorded;
after the scanning step, sweeping by the collector of the memory to reclaim all of the objects that were determined to be unreachable in the scanning step; and
maintaining by the collector of second progress information indicating the collector's progress in sweeping the memory.

14. The method according to claim 13, further comprising the step of:
dividing the objects into at least two groups of objects,
wherein the mutator treats an object in one of the groups different than an object in another of the groups.

15. The method according to claim 13, further comprising the step of maintaining allocation information for each object to indicate if that object was allocated during the scanning step.

16. The method according to claim 10, further comprising the step of executing the mutator concurrently with the scanning step.

17. A method for garbage collection by a collector in a computer system that executes at least one mutator, the method comprising the steps of:
scanning by the collector of a plurality of objects stored in a memory of the computer system so as to create a wavefront behind which are the objects that have already been scanned by the collector, at least some of the objects having a plurality of fields;
after the scanning step, sweeping by the collector of the memory to reclaim all of the objects that were determined to be unreachable in the scanning step;
maintaining by the collector of progress information indicating the collector's progress in sweeping the memory; and
using by the mutator of the progress information to maintain a state of at least one of the objects.

18. The method according to claim 17, wherein in the using state, the state maintained by the mutator indicates whether or not the one object is allocated in the portion of the memory already swept by the collector.

19. The method according to claim 18, further comprising the step of maintaining by the mutator of information indicating whether of not the one object has been recorded from a prior modification of the same garbage collector cycle.

20. The method according to claim 17, wherein only one progress information value is maintained for all of the memory.

21. The method according to claim 17, further comprising the steps of:
recording by the collector of second progress information that indicates the collector's progress in scanning the fields of at least one of the objects; and
changing the behavior of the mutator when mutating the one object based on the second progress information that is currently recorded.

22. The method according to claim 21,
wherein each of the objects stored in the memory has an associated shade value that is compressed into three states, the second progress information for the one object being stored as its associated shade value, and
the method further comprises the steps of:
allocating an object with its associated shade value set to a state that indicates that no fields of that object have been scanned; and
remembering an over-written pointer if that over-written pointer is from an unscanned object.

23. The method according to claim 22, further comprising the steps of:
maintaining allocation information for each object to indicate if that object was allocated during the scanning step; and
setting the shade associated with an object to a state that indicates that all of the fields of the object have been scanned if the allocation information indicates that the object was allocated during the scanning step.

24. The method according to claim 17, further comprising the step of executing the mutator concurrently with the scanning step.

25. A computer-readable medium encoded with a program for garbage collection by a collector in a computer system that executes at least one mutator, the program comprising instructions for performing the steps of:
scanning by the collector of a plurality of objects stored in a memory of the computer system so as to create a wavefront behind which are the objects that have already been scanned by the collector, at least some of the objects having a plurality of fields;
recording by the collector of progress information that indicates the collector's progress in scanning the fields of at least one of the objects; and
changing the behavior of the mutator when mutating the one object based on the progress information that is currently recorded.

26. The computer-readable medium according to claim 25, wherein the program further comprises instructions for performing the steps of:
maintaining reference counts behind the wavefront such that each of the reference counts indicates the number of pointers from already scanned fields of objects to unscanned objects,
wherein the shade value associated with the object is used to maintain the reference count of the object.

27. The computer-readable medium according to claim 26, wherein the program further comprises instructions for performing the steps of:
after the scanning step, sweeping by the collector of the memory to reclaim all of the objects that were determined to be unreachable in the scanning step; and
maintaining by the collector of second progress information indicating the collector's progress in sweeping the memory.

28. A garbage collection system for a computer system that executes at least one mutator, the garbage collection system comprising:
a collector for scanning a plurality of objects stored in a memory of the computer system so as to create a wavefront behind which are the objects that have already been scanned by the collector, at least some of the objects having a plurality of fields,
wherein the collector records progress information that indicates the collector's progress in scanning the fields of at least one of the objects; and
the mutator changes its behavior when mutating the one object based on the progress information that is currently recorded.

29. The garbage collection system according to claim 28, further comprising:
means for maintaining reference counts behind the wavefront such that each of the reference counts indicates the number of pointers from already scanned fields of objects to unscanned objects,
wherein the shade value associated with the object is used to maintain the reference count of the object.

30. The garbage collection system according to claim 29,
wherein after the scanning step, the collector sweeps the memory to reclaim all of the objects that were determined to be unreachable in the scanning step, and
the collector maintains second progress information indicating the collector's progress in sweeping the memory.
